(19) United States
(12) Patent Application Publication
(10) Pub. No.: US 2011/0293351 A1
(43) Pub. Date: Dec. 1, 2011

(54) PRINT CUTTING SYSTEM

(76) Inventors: Brian J. Kwarta, Pittsford, NY (US); James D. Shifley, Spencerport, NY (US)

(21) Appl. No.: 12/789,664

(22) Filed: May 28, 2010

(51) Int. Cl. B41J 11/66

(52) U.S. Cl. 400/621

(57) ABSTRACT

Printer cutting systems are provided. In one aspect, a cutting system has a plurality of cutting devices joined to a frame at different locations within a cutting width of a print transport path. Each of the cutting devices is movable between a first position with a cutter interposed in the print transport path to cut the print as it is moved along the transport path and a second position with the cutter removed from the transport path and each of the cutting devices has a contact surface that moves the cutting device between the first position and second position when engaged. A cam is movably mounted to the frame proximate to the cutting devices and extending across the cutting width of the print transport path, having sets of lobes arranged at a plurality of positions on an outer surface of the cam so that the lobes in each set engage selected ones of the contact surfaces in a manner that causes selected ones of the cutting devices to be moved to the first position and so that movement of the cam to a different position causes a different set of lobes to engage the contact surfaces. A cam actuator that moves the cam in response to signals from a cutting system controller; and a sensor that senses a condition from which the position of the cam can be determined and that provides a signal to a cutting system controller from which the cutting system controller can determine the position of the cam, wherein the cutting system controller receives a signal from which the cutting system controller can determine which combination of cutters is to be used to cut a print and adjusts the position of the cam to cause a desired combination of cutters to be used when that print passes the cutting system.

### CROSS REFERENCE TO RELATED APPLICATIONS

This application relates to commonly assigned, copending U.S. application Ser. No. 12/781,878 filed May 18, 2010, entitled: “SLITTER WITH TRANSLATING CUTTING DEVICES” hereby incorporated by reference.

### FIELD OF THE INVENTION

This invention pertains to the field of finishing printed sheets.

### BACKGROUND OF THE INVENTION

Customers of print jobs can require finishing steps for their jobs. These steps include, for example, folding printed or blank sheets, cutting sheets and trimming sheets to size and shape. For example, when producing business cards, the cards are printed on a large sheet of stiff card stock. After printing, individual cards are produced by cutting the sheets of cards into individual business cards.

Conventional finishing equipment is typically not suited for use in consumer occupied environments such as stores or business establishments, and typically requires trained personnel to safely and effectively use it. Cutters typically include large guillotines that use heavy impacts to cut through thick stacks of paper. For example, the INTIMUS PL265 programmable cutter by MARTIN YALE of Wabash, Ind., cuts up to a 2⅞″ stack of paper and weighs 823 lbs. There is a need, therefore, for smaller, lighter finishing equipment to incorporate into devices used by consumers at home or in retail environments. Furthermore, unlike offset presses which run a large number of copies of a single print job, digital printers can produce small numbers of copies of a job, requiring more frequent changes to the finishing sequence. In some cases, each printed page must be finished individually. Moreover, the PL265 cutter can only store 10 cutting programs, so cannot produce more than 10 cut patterns without manual intervention. There is a need, therefore, for flexible and programmable finishing equipment that can finish each page individually without manual intervention.

The CRICUT cutter by PROVO CRAFT can cut shapes into individual sheets of paper. However, the machine requires manual loading and unloading. Furthermore, the CRICUT moves the sheet to be cut back and forth during cutting, making it unsuitable for high-volume applications that need continuous-speed sheet transport. Similarly, the Triumph 721-06 LT programmable hydraulic cutter and the BC 10 business card cutter sold by MBM Corporation, North Charleston, S.C., USA provides manual feed sheet cutting capabilities that are not suitable for web fed application. It will also be appreciated that these systems use complex electronic control systems to enable flexibility in cutting patterns.

U.S. Publication No. 2005/0079968 to Trovinger describes a sheet folding and trimming apparatus adapted to fold a sheet, trim three edges of the sheet square with the fold, and assemble the folded and trimmed sheets into a booklet. However, this apparatus trims the sides with fixed cutters not suitable for continuous-web operation.

There is a continuing need, therefore, a need to provide a system to enable customized cutting of sheets in small finishing systems. There is also a need to provide such capabilities without complex control systems and without expensive sensing and control capabilities.

### SUMMARY OF THE INVENTION

Printer cutting systems are provided. In one aspect, a cutting system has a plurality of cutting devices joined to a frame at different locations within a cutting width of a print transport path. Each of the cutting devices is movable between a first position with a cutter interposed in the print transport path to cut the print as it is moved along the transport path and a second position with the cutter removed from the transport path and each of the cutting devices has a contact surface that moves the cutting device between the first position and second position when engaged. A cam is movably mounted to the frame proximate to the cutting devices and extending across the cutting width of the print transport path, having sets of lobes arranged at a plurality of positions on an outer surface of the cam so that the lobes in each set engage selected ones of the contact surfaces in a manner that causes selected ones of the cutting devices to be moved to the first position and so that movement of the cam to a different position causes a different set of lobes to engage the contact surfaces. A cam actuator that moves the cam in response to signals from a cutting system controller; and a sensor that senses a condition from which the position of the cam can be determined and that provides a signal to a cutting system controller from which the cutting system controller can determine the position of the cam, wherein the cutting system controller receives a signal from which the cutting system controller can determine which combination of cutters is to be used to cut a print and adjusts the position of the cam to cause a desired combination of cutters to be used when that print passes the cutting system.

### BRIEF DESCRIPTION OF THE DRAWINGS

FIG. 1 is a system level illustration of one embodiment of an electrophotographic printer.

FIG. 2 shows a first embodiment of a cutting system.

FIG. 3 provides a front elevation view of one embodiment of a cutting device.

FIG. 4 provides a side elevation view of the embodiment FIG. 3, in a cutting position.

FIG. 5 provides a side elevation view of the embodiment FIG. 3, in a cutting position.

FIG. 6 shows a chart illustrating various sets of lobes that are provided at various rotational positions of a cam.

FIG. 7 illustrates yet another embodiment of a cutting device in a cutting position.

FIG. 8 illustrates the embodiment of FIG. 7 with the cutting device in a non-cutting position.

### DETAILED DESCRIPTION OF THE INVENTION

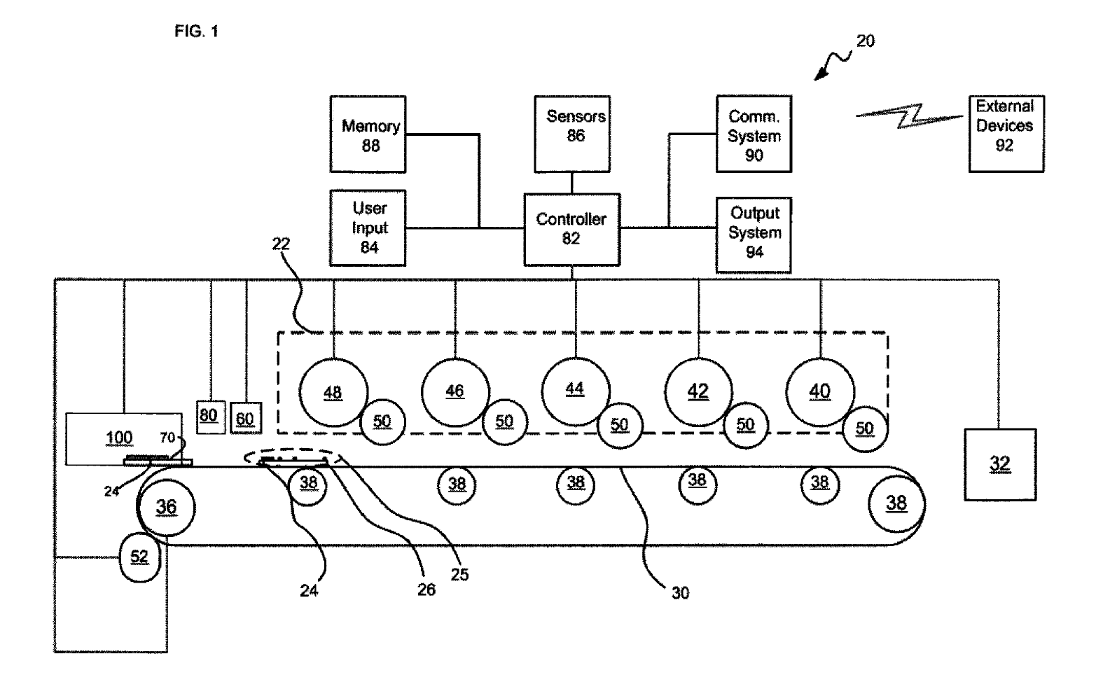

FIG. 1 is a system level illustration of an electrophotographic printer 20. In the embodiment of FIG. 1, electrophotographic printer 20 has an electrophotographic print engine 22 that deposits toner 24 to form a toner image 25 in the form of a patterned arrangement of toner stacks. Toner image 25 can include any patternwise application of toner 24 and can be mapped according data representing text, graphics, photo, and other types of visual content, as well as patterns that are determined based upon desirable structural or functional arrangements of the applied toner 24.

Toner 24 is a material or mixture that contains toner particles, and that can form an image, pattern, or coating when electrostatically deposited on an imaging member including a photoreceptor, photoconductor, electrostatically-charged, or magnetic surface. As used herein, “toner particles” are the marking particles used in an electrophotographic print engine 22 to convert an electrostatic latent image into a visible image. Toner particles can also include clear particles that can provide for example a protective layer on an image or that impart a tactile feel to the printed image.

Toner particles can have a range of diameters, e.g. less than 8 μm, on the order of 10-15 μm, up to approximately 30 μm, or larger. When referring to particles of toner 24, the toner size or diameter is defined in terms of the median volume weighted diameter as measured by conventional diameter measuring devices such as a Coulter Multisizer, sold by Coulter, Inc. The volume weighted diameter is the sum of the mass of each toner particle multiplied by the diameter of a spherical particle of equal mass and density, divided by the total particle mass. Toner 24 is also referred to in the art as marking particles or dry ink.

Typically, receiver 26 takes the form of paper, film, fabric, metallicized or metallic sheets or webs. However, receiver 26 can take any number of forms and can comprise, in general, any article or structure that can be moved relative to print engine 22 and processed as described herein.

Returning again to FIG. 1, print engine 22 can be used to deposit one or more applications of toner 24 to form toner image 25 on receiver 26. A toner image 25 formed from a single application of toner 24 can, for example, provide a monochrome image.

A toner image 25 formed from more than one application of toner 24, (also known as a multi-part image) can be used for a variety of purposes, the most common of which is to provide toner images 25 with more than one color. For example, in a four toner image, four toners having subtractive primary colors, cyan, magenta, yellow, and black, can be combined to form a representative spectrum of colors. Similarly, in a five toner image various combinations of any of five differently colored toners can be combined to form other colors on receiver 26 at various locations on receiver 26. That is, any of the five colors of toner 24 can be combined with toner 24 of one or more of the other colors at a particular location on receiver 26 to form a color different than the colors of the toners 24 applied at that location.

In the embodiment that is illustrated, a primary imaging member (not shown) such as a photoreceptor is initially charged. An electrostatic latent image is formed by image-wise exposing the primary imaging member using known methods such as optical exposure, an LED array, or a laser scanner. The electrostatic latent image is developed into a visible image by bringing the primary imaging member into close proximity to a development station that contains toner 24. The toner image 25 on the primary imaging member is then transferred to receiver 26, generally by pressing receiver 26 against the primary imaging member while subjecting the toner to an electrostatic field that urges the toner to receiver 26. The toner image 25 is then fixed to receiver 26 by fusing to become a print 70.

In FIG. 1 print engine 22 is illustrated as having an optional arrangement of five printing modules 40, 42, 44, 46, and 48, also known as electrophotographic imaging subsystems arranged along a length of receiver transport 28. Each printing module delivers a single application of toner 24 to a respective transfer subsystem 50 in accordance with a desired pattern as receiver 26 is moved by receiver transport 28. Receiver transport 28 comprises a movable surface 30, positions that moves receiver 26 relative to printing modules 40, 42, 44, 46, and 48. Surface 30 comprises an endless belt that is moved by motor 36, that is supported by rollers 38, and that is cleaned by a cleaning mechanism 52.

Also shown in FIG. 1 is an optional folding system 80. Folding system 80 can take the form of any type of folding system that can be used to fold prints 70 as described herein.

Referring again to FIG. 1, electrophotographic printer 20 is operated by a controller 82 that controls the operation of print engine 22 including but not limited to each of the respective printing modules 40, 42, 44, 46, and 48, receiver transport 28, receiver supply 32, transfer subsystem 50, to form a toner image 25 on receiver 26 and to cause fuser 60 to fuse toner images 25 on receiver 26 to form prints 70 as described herein.

Controller 82 operates electrophotographic printer 20 based upon input signals from a user input system 84, sensors 86, a memory 88 and a communication system 90. User input system 84 can comprise any form of transducer or other device capable of receiving an input from a user and converting this input into a form that can be used by controller 82. For example, user input system 84 can comprise a touch screen input, a touch pad input, a 4-way switch, a 6-way switch, an 8-way switch, a stylus system, a trackball system, a joystick system, a voice recognition system, a gesture recognition system or other such systems. Sensors 86 can include contact, proximity, magnetic, or optical sensors and other sensors known in the art that can be used to detect conditions in electrophotographic printer 20 or in the environment-surrounding electrophotographic printer 20 and to convert this information into a form that can be used by controller 82 in governing printing and fusing. Memory 88 can comprise any form of conventionally known memory devices including but not limited to optical, magnetic or other movable media as well as semiconductor or other forms of electronic memory. Memory 88 can be fixed within electrophotographic printer 20 or removable from electrophotographic printer 20 at a port, memory card slot or other known means for temporarily connecting a memory 88 to an electronic device. Memory 88 can also be connected to electrophotographic printer 20 by way of a fixed data path or by way of communication system 90.

Communication system 90 can comprise any form of circuit, system or transducer that can be used to send or receive signals to memory 88 or external devices 92 that are separate from or separable from direct connection with controller 82. Communication system 90 can connect to external devices 92 by way of a wired or wireless connection. In certain embodiments, communication system 90 can comprise a circuitry that can communicate with such separate or separable device using a wired local area network or point to point connection such as an Ethernet connection. In certain embodiments, communication system 90 can alternatively or in combination provide wireless communication circuits for communication with separate or separable devices using a Wi-Fi or any other known wireless communication systems. Such systems can be networked or point to point communication.

External devices 92 can comprise any type of electronic system that can generate wireless signals bearing data that may be useful to controller 82 in operating electrophotographic printer 20. For example and without limitation, an external device 92 can comprise what is known in the art as a digital front end (DFE), which is a computing device that can be used to provide images and or printing instructions to electrophotographic printer 20.

An output system 94, such as a display, is optionally provided and can be used by controller 82 to provide human perceptible signals for feedback, informational or other purposes. Such signals can take the form of visual, audio, tactile or other forms.

As is shown in FIG. 1, electrophotographic printer 20 further comprises a cutting system 100. Cutting system 100 can be integral to printer 20 or it can be separate or separable from printer 20.

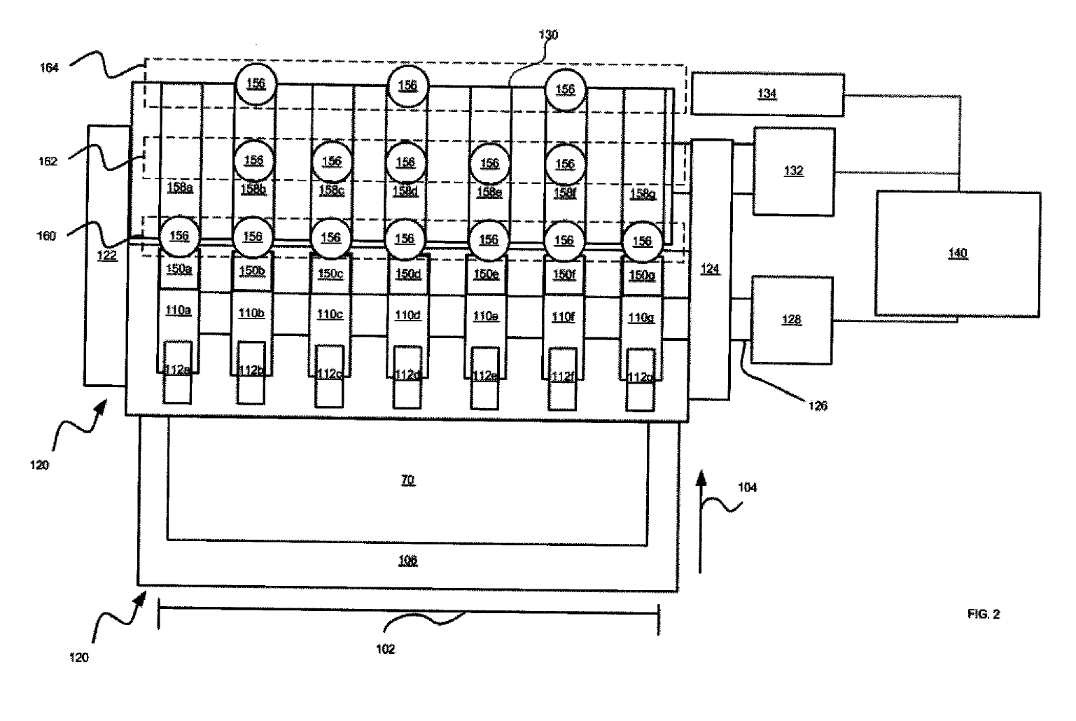

FIG. 2 shows a first embodiment of cutting system 100. In this embodiment, cutting system 100 is integral to printer 20 and provides a cutting width 102 across a print transport path 104 within which cutting system 100 can cut a print 70 as print 70 is moved along print transport path 104 by a print transport system 106. As is shown in the embodiment of FIG. 2 cutting system 100 has a plurality of cutting devices 110 shown here as cutting devices 110a, 110b, 110c, 110d, 110e, 110f, and 110g. Each cutting device 110 has a cutter 112 that is capable of cutting a print 70 into at least two parts as print 70 is moved past cutter 112. In the embodiment of FIG. 2, cutters 110a, 110b, 110c, 110d, 110e, 110f, and 110g are provided respectively for cutting devices 110a, 110b, 110c, 110d, 110e, 110f, and 110g.

Cutting devices 110 are provided on a frame 120 that has side members 122 and 124 on either side of cutting width 102. Side members 122 and 124 support a cross member 126, that extends across cutting width 102. As shown in FIG. 1, cutting devices 110 are distributed along cross member 126 at predetermined cutting locations. Cutting devices 110 are pivotally mounted to cross member 126 allowing cutting devices 110 to rotate relative to each other.

In the embodiment shown in FIG. 2, cross member 126 takes the optional form of a geared shaft that is rotatably mounted to frame 120 in a manner that allows cross member 126 to rotate relative to frame 120. A shaft actuator 128 is provided and can comprise a motor to cause this geared shaft embodiment of cross member 126 to rotate. However, in other embodiments, shaft actuator 128 can comprise any apparatus that can controllably supply energy to rotate cam 130.

Frame 120 also supports a cam 130 that extends across the cutting width 102. Cam 130 is positioned proximate to cutting devices 110 as will be described in greater detail below. A cam actuator 132 is provided to rotate cam 130. Here, cam actuator 132 comprises a motor that rotates to cause cam 130 to rotate. However, in other embodiments, cam actuator 132 can comprise any apparatus that can controllably supply energy to rotate cam 130.

A cam sensor 134 is provided and can take the form of any known type of mechanical, magnetic, optical or electrical sensor that senses a condition from which the position of the cam can be determined and that generates a signal that a cutting system controller 140 can use to determine a position of cam 130. In one non-limiting example embodiment, cam sensor 134 comprises an optical sensor that senses a pattern of markings on cam 130 that indicate a position of cam 130.

Cutting system controller 140 can take the form of any known type of control logic circuit or system that is capable of receiving signals from a printer controller 82 and from a cam sensor 134 and operating cam actuator 132 in response to signals received from printer controller 82. In an alternative embodiment, printer controller 82 can perform the functions of cutting system controller 140.

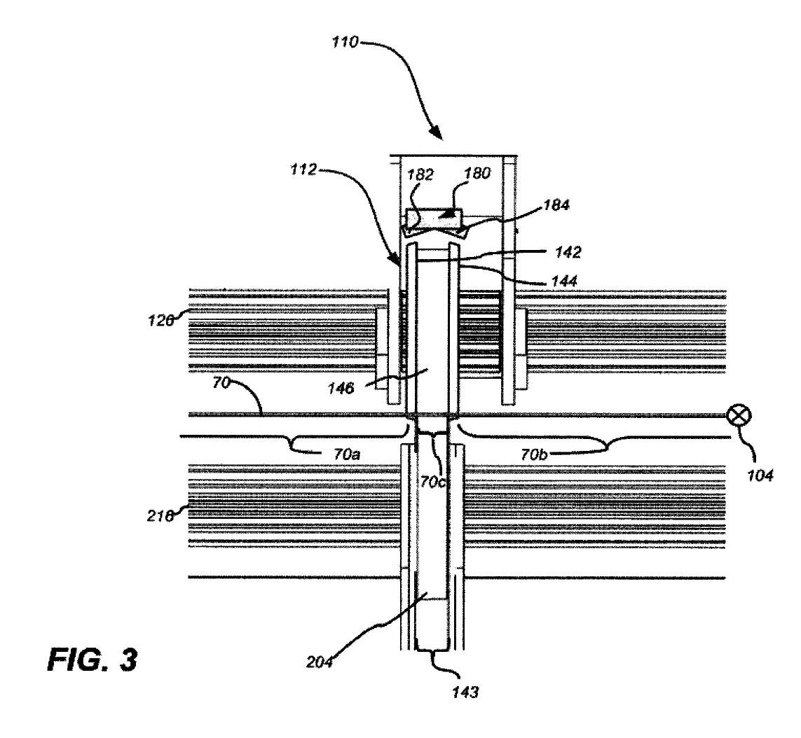

FIGS. 3, 4 and 5 provide front and side elevation views of one embodiment of a cutting device 110. As shown in FIGS. 3, 4, and 5 in the embodiment illustrated, each cutting device 110 has a cutter 112 with two cutting surfaces shown as cutting wheel 142 and cutting wheel 144. A pressure wheel 146 is positioned between cutting wheel 142 and cutting wheel 144 separating cutting wheels 142 and 144. In this embodiment, cutting wheels 142 and 144 are pressed tightly against pressure wheel 146.

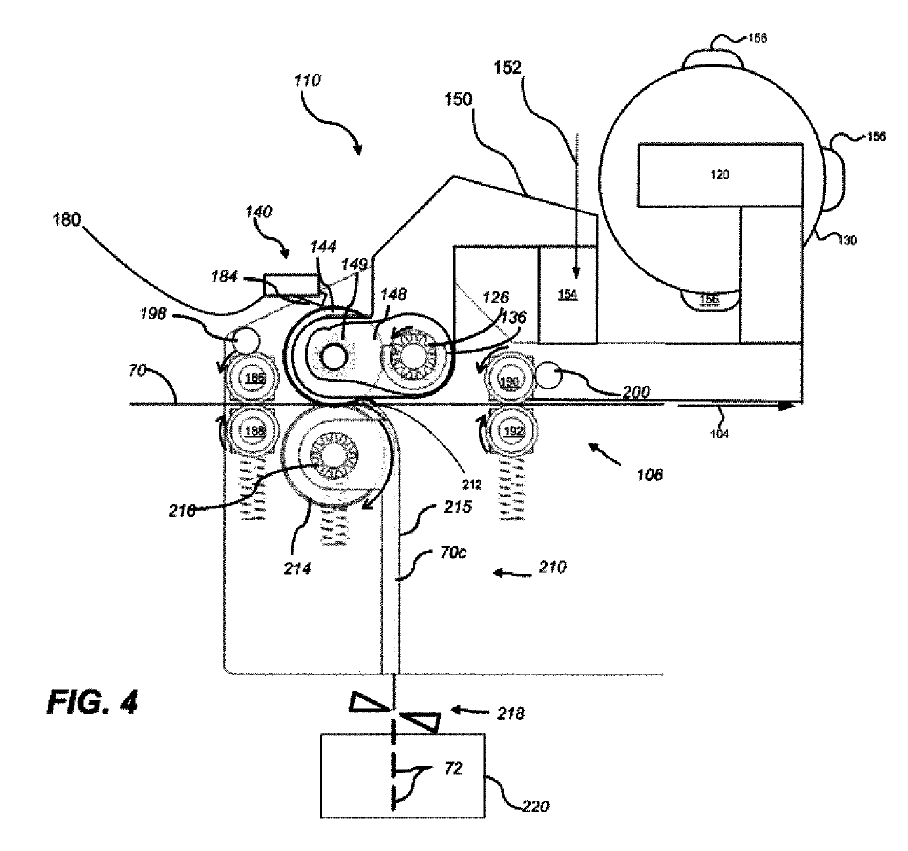

Accordingly, cutter 112 of FIGS. 3 and 4 cuts a print 70 into three parts a first part 70a and a second part 70b with a chad part 70c between the first part 70a and the second part 70b. It will be appreciated that in this embodiment a separation between cutting wheel 142 and cutting wheel 144 defines chad width 143 of chad part 70c. In other embodiments, cutter 112 can comprise a single cutting wheel, a scoring blade, a keel knife, or any other known mechanical device for cutting print 70 into at least two parts.

As discussed above, and as is shown cutaway in FIG. 4, cross member 126 takes the form of a geared shaft that rotates cutting wheel 142, cutting wheel 144 and/or pressure wheel 146 by way of a gear system 145. In the embodiment illustrated gear system 145 is shown having a meshing gear 148 that links cross member 126 to a wheel gear 149 that drives any of cutting wheel 142, cutting wheel 144 or pressure wheel 146. Other gearing arrangements can be provided in alternative embodiments. The rate of rotation of cutting wheels 142, cutting wheel 144 and pressure wheel 146 is synchronized to the rate of movement of print 70 rate of movement of print 70 along print transport path 104.

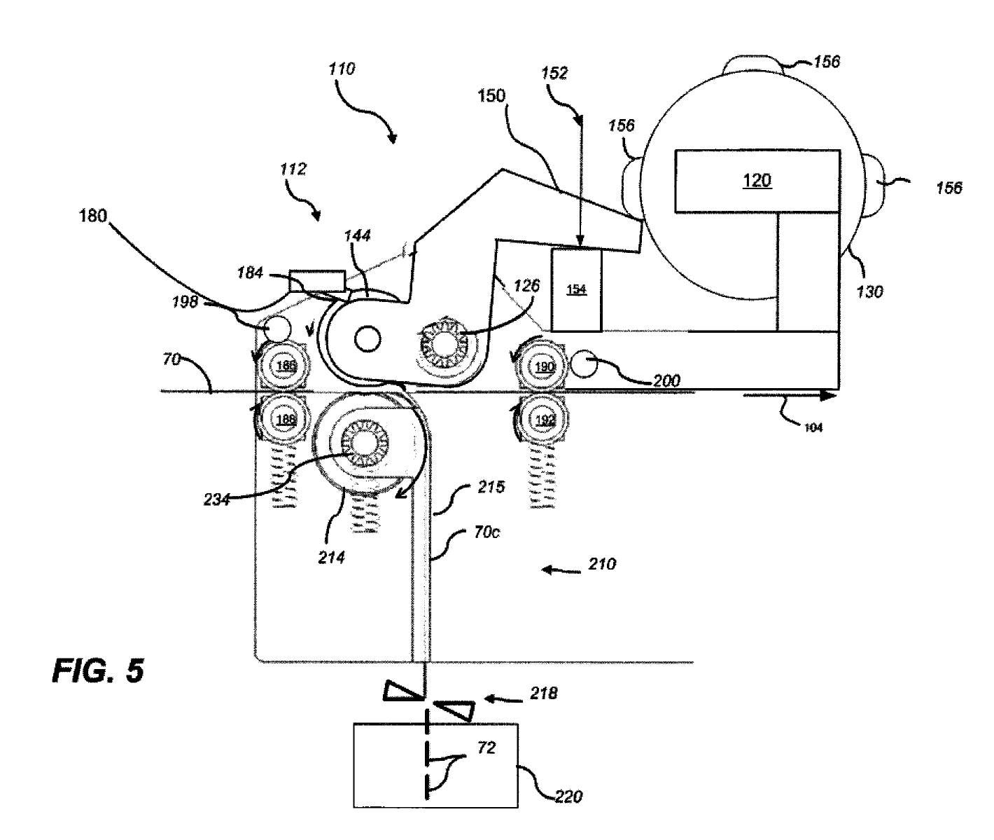

Cutting device 110 is pivotally mounted to cross member 126 at bearing 136 such that cutting device 110 can be pivoted around cross member 126 between a first position shown in FIG. 4 and a second position shown in FIG. 5. When cutting device 110 is positioned in the first position, cutter 112 is moved into the print transport path 104 and will not cut a print 70 moved along print transport path 104. When cutting device 110 is positioned in the second position, cutter 112 is moved out of print transport path 104 and will not cut a print 70 moved along print transport path 104.

As is also shown in FIGS. 4 and 5, cutting device 110 has a contact surface 150 that can be pressed, for example, along axis 152 to drive cutting device 110 between the first position and the second position. In this embodiment, a biasing member 154 is also shown that biases cutting device 110 into the first position unless a force is applied against contact surface 150 to drive contact surface 150 along axis 152. In another embodiment, cutting device 110 is biased into the non-cutting second position and such that cutting device 110 only moves to a position where cutter 112 can cut print 70 when a cam 130 is positioned such that a lobe 156 drives a contact surface along axis 152 from the opposite direction.

In this embodiment, cam 130 has lobes 156 that project sufficiently from cam 130 to bridge the distance between cam 130 and contact surface 150. Here, cutting devices 110 and came 130 are arranged on frame 120 so that lobes 156 are brought into or out of contact with contact surface 150 based upon a rotational setting of cam 130.

Returning to FIG. 2, it will be observed that cam 130 provides lobes 156 in a plurality of contact areas 158a, 158b, 158c, 158d, 158e, 158f, and 158g that are associated with each of contact surfaces 150a, 150b, 150c, 156d, 156e, 156f and 156g so that lobes 156 can be positioned to drive contact surfaces 150a, 150b, 150c, 150d, 150e, 150f, and 150g respectively to urge cutting devices 110a, 110b, 110c, 110d, 110e, 110f and 110g into the second position against the bias that is supplied by biasing member 154. As can be seen in FIG. 2, lobes 156 are arranged in sets 160, 162, and 164 that are distributed at various locations along cam 130 that are associated with cutting surfaces 150. Accordingly, the exact combination of lobes 156 that are brought into contact with the contact surfaces 150 depends on the rotational position of cam 130.

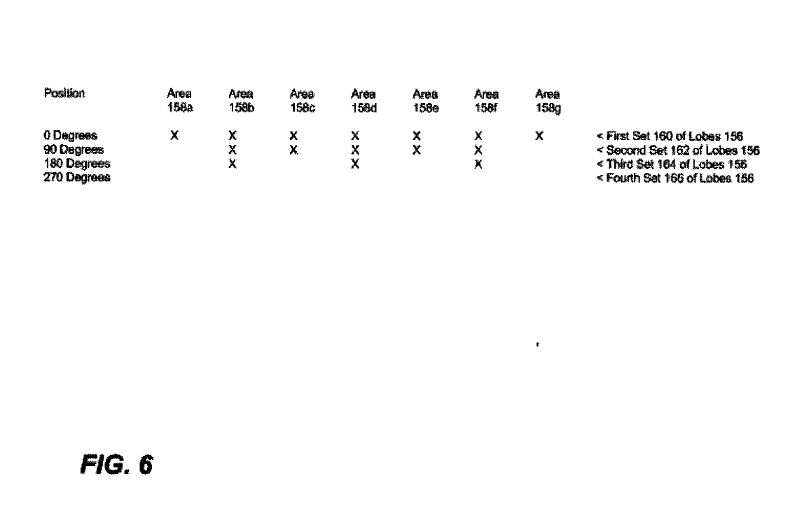

FIG. 6 shows a chart illustrating sets of lobes 156 that are provided at various rotational positions of cam 130 of FIG. 2, in order to define which of cutting devices 110a, 110b, 110c, 110d, 110e, 110f, and 110g are to be used to cut a print 70. Each set of lobes 156 is provided at a different angle of rotation of cam 130 so that many combinations of many cutting devices 110a, 110b, 110c, 110d, 110e, 110f, and 110g can be selected using cam 130.

As is shown in FIG. 6, when cam 130 is at a 0 degree of rotation position, a first set 160 of lobes 156 is provided on cam 130 that provides lobes 156 in contact surfaces 150a, 150b, 150c, 150d, 150e, 150f, and 150g. Accordingly, a print 70 that is processed by cutting system 100 with cam 130 in the 0 degree position will not be cut.

However, when cam 130 is rotated by 90 degrees, a second set 162 of lobes 156 is moved into contact with contact surfaces 150. Here, the second set 162 has lobes 156 in contact areas 158b, 158c, 158d, 158e and 159f so that cutting devices 110a and 110g will be in contact with print 70. These cuts cause edges of print 70 to be removed. This can be used, for example, and without limitation, to create a single cut print that appears to have been printed from edge to edge. This can be useful, for example, where printer 20 cannot print to the edges of receiver 26 on which print 70 is formed.

As is further shown in FIG. 6, when cam 130 is positioned at a 180 degree position, cam 130 moves a third set 164 of lobes 156 into a position to engage contact surfaces 150. In this embodiment, lobes 156 are provided in contact areas 158b, 158d, and 158f and contact surfaces 150b, 150d, and 150f to cut a print 70 into three different borderless portions.

Finally, in the embodiment that is illustrated in FIG. 6, cam 130 can be rotated into a 270 degree position where a fourth set 166 of lobes 156 is brought into engagement with contact surfaces 150. The fourth set 168 of lobes 156 is a null set having no lobes. Accordingly, all cutting devices 110 will be engaged cutting print 70 into six borderless portions.

It will be understood that this example is not limiting and that a wide variety of combinations sets of lobes can be provided that will drive different combinations of cutters into contact with print 70 and that more or fewer sets of lobes can be provided on cam 130 using more or fewer different angular positions.

Returning to FIG. 2, it will be observed that cutting system controller 140 is connected to and can operate cam actuator 132 to move cam 130 to any desired angular position. To provide feedback to ensure proper positioning of cam 130, a cam sensor 134 is provided that can monitor cam 130 and that provides signal to cutting system controller 140 from which cutting system controller 140 can determine the position of cam 130 so that cutting system controller 140 can send appropriate signals to cam actuator 132 to position cam 130 at a position that causes a desired set of lobes 156 to engage contact surfaces 150. Cutting system controller 140 determines the position of the cam 130 based on signals received from printer controller 82 indicating a desired combination of cuts to be applied to a print 70 and determines an appropriate position for cam 130 to provide the desired combination of cuts of print 70.

It will be appreciated, that this arrangement permits a plurality of different cutting options to be selected and set by a printer controller 82 without requiring electronic controls, sensors and actuators to individually actuate each of the plurality of cutting devices 110. Such an approach greatly reduces the cost of a cutting system 100 while preserving the ability to provide a large number of different combinations of cuts on a print 70.

In this embodiment, printer controller 82 receives print order information defining what is to be printed on a receiver 26 and a desired size of a cut print to be provided by a print 70 formed from receiver 26. Printer controller 82 can then determine which set of cutters is to be used to cut the print 70 such that print 70 has the desired end size and can send signals to cutting system controller 140 from which cutting system controller 140 can determine which position to move cam 130 to in order to achieve the desired cuts when the print 70 has been printed and advanced along print transport system 106 through cutting system 100. Printer controller 82 then causes print 70 to be formed and positioned on receiver 26 so that the portion of print 70 that will be cut includes the desired printed images.

It will be understood that in other embodiments, printer controller 82 can drive cam actuator 132 and monitor cam sensor 134 directly. In still other embodiments, printer controller 82 can pass along print order data to cutting system controller 140 from which cutting system controller 140 can determine which sets of cutters are to be used and can cause cam actuator 132 to position cam 130 in a position that causes such cutters 112 to be used in cutting print 70. Optionally, information from which printer controller 82 or cutting system controller 140 can use to determine how to cut a print 70 can be provided in other ways such as by way of a user input system 90.

The embodiment of FIGS. 3, 4 and 5 also shows an optional cutter sharpener 180 that is positioned so that sharpeners 182 and 184 engage cutting wheels 142 and 144 respectively when cutting device 110 is in the non-cutting position. Here sharpeners 182 and 184 can comprise stationary sharpening surfaces as rotation of cross member 126 can be used to cause cutting wheels 142 and 144 to rotate relative to such stationary sharpeners 182 and 184. Sharpeners 182 and 184 can comprise generally, any type of material known that will have properties such as a hardness that is sufficient to sharpen cutting wheels 142 and 144 or any other form of cutter 112 provided. In other embodiments, optional cutter sharpener 180 can have movable sharpeners that are positioned to engage a cutter 112 that is in the second or non-cutting position.

Print transport system 106 can comprise any known method for conveying print 70 past cutting system 100. However, FIGS. 3, 4 and 5 show one embodiment of a print transport system 106 that takes the form of a pair of lead pinch rollers 186 and 188 and trailing pinch rollers 190 and 192 that are positioned in opposition across print transport path 104 and biased against each other by biasing members 194 and 196. A first pinch roller motor 198 drives one of lead pinch rollers 186 and 188, here shown as pinch roller 186, and a second pinch roller motor 200 drives one of trailing pinch roller 190 or trailing pinch roller 192, shown here as pinch roller 190, to cause trailing pinch rollers 190 and 192 to rotate in the directions shown to receive print 70 for example from a receiver transport system 28. Further, as is shown in FIGS. 3, 4 and 5 an opposition roller 204 can be provided opposite to and biased against pressure wheel 146. As shown, opposition roller 204 is powered by a rotating shaft 216 which is also powered for example by shaft actuator 128. This arrangement provides powered movement of print 70 through the cutting system 100 that can be controlled for example by cutting system controller 140 if desired.

As is shown in FIGS. 4 and 5, in this embodiment chad part 70c is optionally diverted by a chad diverter system 210 comprising a chad diverter 212 that extends from cutting device 110 to direct chad part 70c away from print transport path 104 along a path 215 through a shredder 218 to which cuts chad part 70c into smaller pieces 72 and allows these to accumulate in a storage area 220. In other embodiments, chad part 70c can be processed in other ways either through a chad diverter system at cutting system 100 or elsewhere in printer 20.

It will be appreciated that where cutting devices 110 are used that create a chad part 70c in addition to cut parts 70a and 70b, printer controller 82 can arrange images printed on print 70 to cause a border between two image areas formed on print 70 to be printed so that border and a portion of each printed image is in chad part 70c. This renders cut prints that have no border without requiring precise cutting alignment at the cutting edge of such prints.

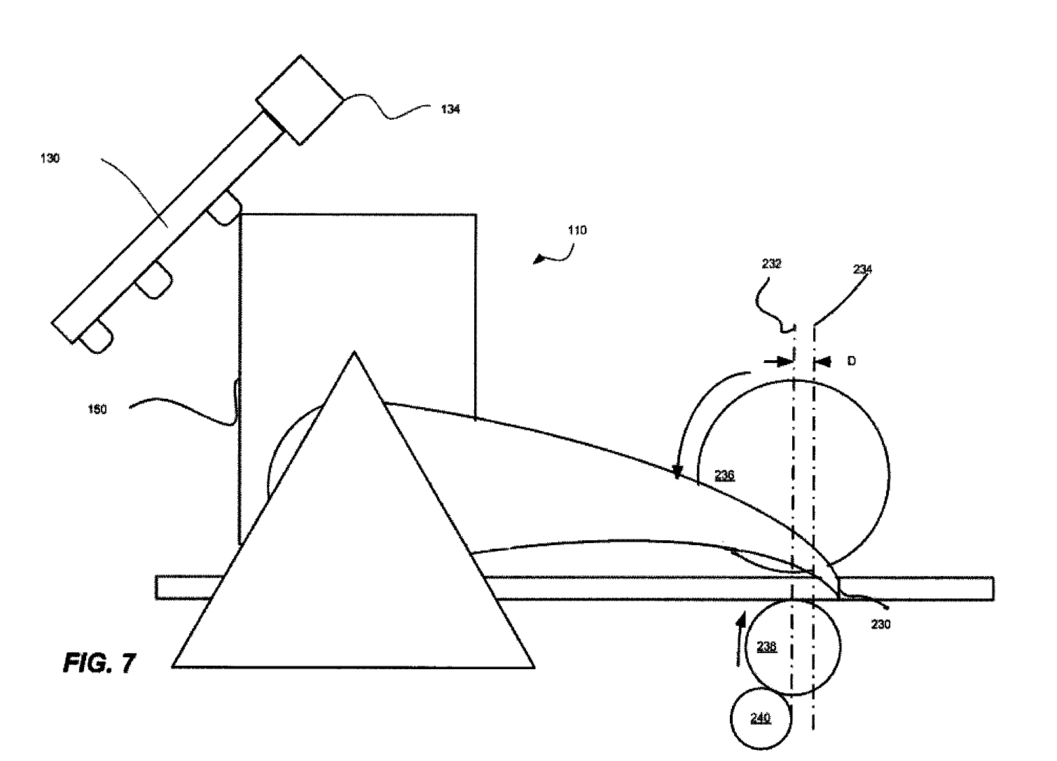

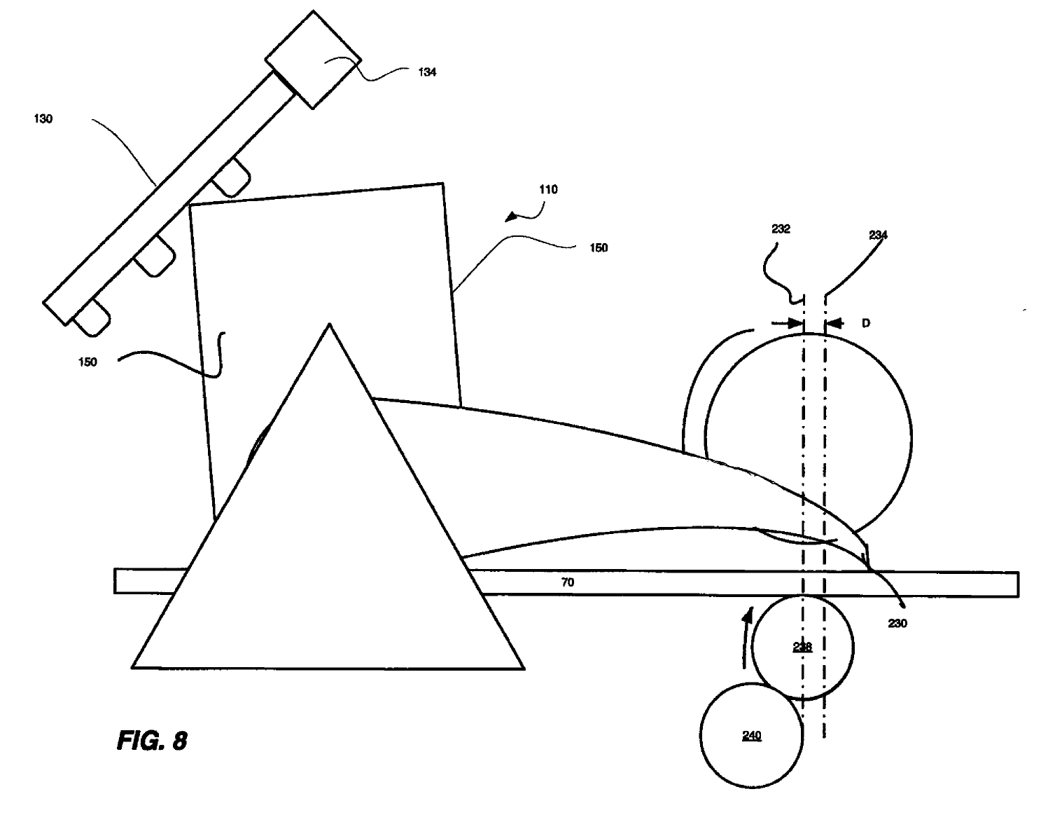

FIGS. 7 and 8 illustrate yet another embodiment of a cutting device 110 that is pivotally mounted to a cross member 126 of a frame 120 and is movable between a non-cutting position shown in FIG. 7 and a cutting position shown in FIG. 8 as is generally described above. However, it will be noted that in this embodiment cutter 112 is moved to the cutting position when lobes 156 engage contact surface 150 and is moved out of the cutting position when lobes 156 do not engage contact surface 150. Further, as is shown in this embodiment, cam 130 can be arranged on a planar surface which is moved by cam actuator 132 that pulls cam 130 across contact surface 150 such that different sets of lobes 156 engage contact surface 150.

As is shown in the embodiment of FIGS. 7 and 8, cutter 112 takes the form of a keil knife 230 which cuts print 70 at a cutting line 234. As also shown in FIGS. 7 and 8, cutting line 232 is proximate to but separate from a nip line 232 between a pair pinch rollers 236 and 238 which are urged together across print transport path 104 and are powered by a pinch roller actuator 240 drive print 70 along print transport path 104. Here, separation D is sized to allow pinch rollers 236 and 238 to drive print 70 into keil knife 230 without support structure over a distance D that is sized so that the column strength of print 70 over such a short distance is sufficient to prevent buckling of print 70 between the nip line 232 and cut line 234. The distance D over which lead pinch rollers 186 and 188 can advance print 70 into keil knife 230 can be in the range of 0.5 to 1.5 mm, however, the exact distance for any particular type of print 70 be a function of several factors, including for example, the beam strength of print 70, the strength of any toner or other materials bonded to print 70 and can be more or less than this range.

Cam actuator 132 has been described above as comprising a dedicated motor. However, in other embodiments, cam actuator 132 can take the form of a transmission or clutch that can form a mechanical link between a motor or other actuator that is used for some other purpose in response to a signal from cutting system controller 140 to cause cam 130 to rotate. For example, in one embodiment cam actuator 132 provide a link to a motor that is used to advance print 70 along print transport path 104 or for example shaft actuator 128. Where cutting system 100 is mounted to a printer that provides a transport path such as an endless belt that passes cutting system 100, a follower wheel (not shown) can selectively be moved into or out of position with such an endless belt or powered roller arrangement to provide selectively provide mechanical energy to drive cam 130.

Cam 130 has been shown in the embodiments above as being cylindrical or planar in form. This is, however, non-limiting and other forms of cam 130 can be used, including curved forms and flexible forms such as belts or other webs so long as cam 130 provides variations in the contact areas 158 with portions that extend closer to contact surfaces 150 than other portions of the contact areas 158 to engage the contact surfaces 150 such that the position of cam 130 relative to contact surfaces 150 causes selected ones of cutting devices 110 to move to a cutting position.

In the forgoing printer 20 has been described as an electrophotographic printer. However, it will be appreciated by those of skill in the art that the cutting system 100 described herein can be used with other forms of printers including ink jet, thermal, lithographic, flexographic or other types of printing.

As noted above, cutter 112 can comprise any structure that can cut a print 70 into at least two parts. In this regard, cutting device 110 and cutter 112 can use any known cutting or slitting technology to cut print 70 including but not limited to razor in air slitting, razor in groove slitting, score slitting, burst shear slitting, tangent (kiss) shearing or wrap shear slitting.

The invention has been described in detail with particular reference to certain preferred embodiments thereof, but it will be understood that variations and modifications can be effected within the spirit and scope of the invention.

### PARTS LIST

20 printer
22 print engine
24 toner
25 toner image
26 receiver
28 receiver transport
30 surface
32 receiver supply
36 motor
38 rollers
40 printing module
42 printing module
44 printing module
46 printing module
48 printing module
50 transfer subsystem
52 cleaning mechanism
60 fuser
70 print
70a first part of print
70b second part of print
70c chad part of print
80 automatic folding system
82 controller
84 user input system
86 sensors
88 memory
90 communication system
92 external device(s)
94 output system
100 cutting system
102 printing width
104 print transport path
106 print transport system
110 cutting device
110a cutting device
110b cutting device
110c cutting device
110d cutting device
110e cutting device
110f cutting device
110g cutting device
112 cutter
112a cutter
112b cutter
112c cutter
112d cutter
112e cutter
112f cutter
112g cutter
120 frame
122 side member
124 side member
126 crossmember
128 shaft actuator
130 cam
132 cam actuator
140 cutting system controller
142 cutting wheel
143 distance
144 cutting wheel
145 gear system
146 pressure wheel
148 meshing gear
149 wheel gear
150 contact surface
150a contact surface
150b contact surface
150c contact surface
150d contact surface
150e contact surface
150f contact surface
150g contact surface
152 axis
154 biasing member
156 lobe
156a lobe
156b lobe
156c lobe
156d lobe
156e lobe
156f lobe
156g lobe
156 lobe
158a contact area
158b contact area
158c contact area
158d contact area
158e contact area
158f contact area
158g contact area
160 first set of lobes
162 second set of lobes
164 third set of lobes
166 fourth set of lobes
180 cutter sharpener
182 sharpener
184 sharpener
186 lead pinch roller
188 lead pinch roller
190 trailing pinch roller
192 trailing pinch roller
194 biasing member
196 biasing member
198 first pinch roller motor
200 roller motor
204 opposition roller
206 rotating shaft
210 diverter system
212 chad diverter
216 path
218 shredder
220 storage area
230 keil knife
232 nip line
236 pinch roller
238 pinch roller
240 pinch roller actuator

What is claimed is:

1. A cutting system comprising:
a plurality of cutting devices joined to a frame at different locations within a cutting width of a print transport path, each of the cutting devices is movable between a first position with a cutter interposed in the print transport path to cut the print as it is moved along the transport path and a second position with the cutter removed from the transport path and each of the cutting devices has a contact surface that moves the cutting device between the first position and second position when engaged;
a cam movably mounted to the frame proximate to the cutting devices and extending across the cutting width of the print transport path, having sets of lobes arranged at a plurality of positions on an outer surface of the cam so that the lobes in each set engage selected ones of the contact surfaces in a manner that causes selected ones of the cutting devices to be moved to the first position and so that movement of the cam to a different position causes a different set of lobes to engage the contact surfaces;
a cam actuator that moves the cam in response to signals from a cutting system controller; and
a sensor that senses a condition from which the position of the cam can be determined and that provides a signal to a cutting system controller from which the cutting system controller can determine the position of the cam,
wherein the cutting system controller receives a signal from which the cutting system controller can determine which combination of cutters is to be used to cut a print and adjusts the position of the cam to cause a desired combination of cutters to be used when that print passes the cutting system.

2. The cutting system of claim 1, wherein the cutter comprises a pair of wheel cutters.

3. The cutting system of claim 1, wherein the cutter comprises a keil knife that is positioned proximate but separated from a point at which the print is driven along the print transport path such that the print can be driven against and cut by the keil knife without buckling the print.

4. The cutting system of claim 1, wherein a cutter sharpener is positioned to engage and to sharpen the cutter when the cutter is in the second position.

5. The cutting system of claim 1, wherein the cam actuator is adapted to receive a signal from the cutting system controller and, in response to the signal, to transfer energy to move the cam using energy from an actuator that is used for purposes other than positioning the cam.

6. The cutting system of claim 1, wherein at least one of the cutters cuts the print into three parts including a chad part.

7. The cutting system of claim 1, wherein at least one of the cutters cuts the print into three parts including a chad part and further comprising a chad diverter that is interposed into the print transport path after the cutters to direct the chad part out of the print transport path when the cutting device is in the first position, with the chad diverter being removed from the transport path when the cutting device is in the second position.

8. The cutting system of claim 1, wherein the cutting device provides a pair of pinch rollers urged together in opposition across the print transport path at a nip line to urge the print along the print transport path from the nip line to a cutting position where a keil knife cuts the print, wherein the keil knife is separated from the nip line by a distance that is defined as being short enough for the column strength of the print to allow the print to be driven from the nip line to the keil knife without buckling.

9. A printer comprising:
a print engine to form a print having an image on a receiver;
a print transport system that moves a print along a print transport path;
a cutting system having a frame that provides a cross member extending across a cutting width that extends across the print transport path;
a plurality of cutting devices joined to the cross member at one of a plurality of locations across the cutting width, with each cutting device being movable between a cutting position where a cutter is positioned to cut the print as it is moved past the cutter on the print transport path and a non-cutting position where the cutter is positioned out of the print transport path and with the cutting devices having a contact surface that can be contacted to move the cutter between the cutting position and the non-cutting position;
a cam mounted to the frame having a plurality of contact areas with each of the contact areas being positioned proximate to an associated one of the contact surfaces; and,
a cam actuator that moves the cam in response to signals from a controller; and
a sensor that senses a condition from which a position of the cam can be determined and that provides a signal to the controller that the controller can use to cause a cam actuator to position the cam at a determined position;
wherein the cam provides variations in the contact areas that have portions that extend closer to the contact surfaces than other portions of the contact areas to engage the contact surfaces such that the position of the cam relative to the contact surfaces causes selected ones of the cutting devices to move to the cutting position and wherein the controller causes a print to be printed, determines where the print is to be cut, causes the cam to be positioned so that the cutters are positioned to cut the print as determined and causes the print transport system to move the print past the cutting system to provide a cutting of the print.

10. The printer of claim 9, wherein the cutter comprises a wheel.

11. The printer of claim 9, wherein a cutter sharpener is positioned to engage and to sharpen the cutter when the cutter is in the second position.

12. The printer of claim 9, wherein cam actuator is selectively linked to transfer energy to move the cam from an actuator that is used for purposes other than the positioning of the cam.

13. The printer of claim 9, wherein the cutter comprises two cutting surfaces to cut the print into three parts including a chad part cut from an area of the print that is between the at least two cutting surfaces and wherein the printer causes a border between two image areas formed on the print to be printed so that border and a portion of each printed image is in the chad area.

14. The printer of claim 9, wherein the cutter has two cutting surfaces to cut the print into three parts including a chad part cut from an area of the print that is between the cutting surfaces and a chad diverter that is interposed into the print transport path after the cutters to direct the chad part out of the print transport path, with the chad diverter being removed from the transport path when the cutting device is in the second position.

15. The printer of claim 9, wherein the cutting device provides a pair of pinch rollers urged together in opposition across the print transport path at a nip line to urge the print along the print transport path from the nip line to a cutting position where a keil knife cuts the print, wherein the keil knife is separated from the nip line by a distance that is defined as being short enough for the column strength of the print to allow the print to be driven from the nip line to the keil knife without budding.

16. A cutting system comprising:
a plurality of cutting means having means for cutting a paper when in a first position and for not cutting the paper when in a second position;
a means for mounting the plurality of cutting means at a plurality of different locations across a print transport path that extends past the plurality of cutting means and for movably positioning;
a contact means proximate to the cutting means and having sets of contacts to arranged to move selected cutting means between the first position and the second position and distributed at different positions on the contact means;
a means for moving the contact means to bring different sets of contacts into contact with the cutting means;
a sensor means for sensing the position of the pressure means; and
a controller that has a means for determining which cutting means are to be used to cut the paper, and means for using the actuator means and the sensor means to position the contact means at a position where the set of contacts causes the determined cutting of the paper.
